(19) United States
(12) Patent Application Publication
(10) Pub. No.: US 2008/0040225 A1
(43) Pub. Date: Feb. 14, 2008

(54) METHOD AND SYSTEM TO PROCESS A REQUEST FOR AN ADVERTISEMENT FOR PRESENTATION TO A USER IN A WEB PAGE

(76) Inventor: Robert Roker, Vancouver (CA)

Correspondence Address: SCHWEGMAN, LUNDBERG & WOESSNER, P.A., P.O. BOX 2938, MINNEAPOLIS, MN, 55402, US

(21) Appl. No.: 11/836,933

(22) Filed: Aug. 10, 2007

Related U.S. Application Data
(63) Continuation of application No. 11/815,747.
(60) Provisional application No. 60/649,911, filed on Feb. 7, 2005.

(51) Int. Cl. G06Q 30/00

(52) U.S. Cl. 705/14

(57) ABSTRACT

A system and method of processing a request for an advertisement for presentation to a user in a web page is described. The method may comprise, in an Internet Service Provider (ISP) network, receiving an HTTP advertisement request from a user device, the advertisement request destined for an associated destination content server. Thereafter, the advertisement request may be intercepted prior to communication of the advertisement request by the ISP network to the associated destination content server. User data associated with the user may be accessed and the advertisement request may be modified by including a trigger code that triggers the associated destination content server to redirect the advertisement request to a new destination content server.

### RELATED APPLICATIONS

This application is a continuation of U.S. application Ser. No. 11/815,747, filed on Aug. 7, 2007, which is a U.S. National Stage Filing Under 35 U.S.C. 371 from International Application No. PCT/CA2006/000157, filed Feb. 7, 2006, and published in English as WO 2006/081680 on Aug. 10, 2006, which claims the benefit of priority under 35 U.S.C. 119(e) to U.S. Provisional Application Ser. No. 60/649,911, filed on Feb. 7, 2005, which applications and publications are incorporated herein by reference.

### FIELD OF THE INVENTION

This invention relates to distribution of content on a wide area network, such as the Internet, and more particularly to allowing service providers to distribute individualized content to their users.

### BACKGROUND OF THE INVENTION

The Internet began as a non-commercial medium of information exchange, however this was short-lived. Online advertisers altered the public Internet environment, and in doing so, created some annoyances and unwanted results for users of the Internet. Such users now find themselves overwhelmed with popup windows, pop-under windows, banner advertisements and other Internet “clutter,” most of which is neither relevant nor useful to the particular user.

Such Internet clutter is the result of online advertisers constructing online campaigns that are the electronic equivalent of a driftnet. These online campaigns cast as wide a net as possible, with little concern for relevance to a particular user. With minimal targeting methods and difficulties in measuring results, such Internet advertising produced questionable returns for advertisers and annoyances for users.

Internet advertising has responded to pressure from both advertisers and public interest groups representing users. Online advertisements used new shapes, sizes and graphics to combat the clutter of banner advertisements. Search technologies began a trend towards categorizing and segmenting Internet users into smaller, more marketable subgroups. Internet search portal providers, such as those provided by Yahoo!™, introduced paid-search advertising that linked the online advertisements presented to a user to that user's search subjects. For example, users searching for information about exotic travel destinations might be presented with advertisements offering deals on cruise wear or advertisements from a major swim wear line. By 2003, Internet advertising saw a return of larger companies, attracted by the better targeting and increased relevance of the advertisements. As advertising purchasers responded, so have Internet users who, in various polls, have indicated a desire to make the Internet more relevant to their needs and therefore more personal.

There are difficulties with online profiling conducted to determine the relevancy of advertising. For the typical user, ad ware, spy ware and other invasive online tracking and profiling methods are to be avoided. These types of programs are designed to exploit the operating systems of individual computers and may expose the user to unwanted, irrelevant content and advertisements. The most pervasive of these methods are the placement of “cookies”, i.e. small text files residing on websites that are stored on the hard drive of a user's computer. The cookies record aspects of the user's activities and deliver that information back to the website provider. As well as cookies, invisible graphics known as “web bugs” may reside on websites or within emails, for collecting personal information. Invasive ad ware and spy ware products often find their way onto a user's computer by disguising themselves as promotional gimmicks or add-on services for the user.

Some recent research has suggested Internet users are not opposed to the collection of their personal information, however, most users want some level of control over how the information is collected and for what purposes it is disclosed. A Business Week™/Harris™ poll published in 2004 revealed that 77% of respondents wanted to be able to opt-in “all the time” before information about their browsing habits or shopping patterns is collected. In addition, 86% of those polled wanted opt-in privileges for all collection of their personally identifiable information such as their name, address, and phone numbers.

In the offline world, profiling is commonplace, for example customers will readily volunteer their personal information each time they subscribe to a magazine, use a loyalty card, or respond to a promotional contest. A key difference between online information collection and offline is that offline, the collector is usually readily identifiable. Consumers are generally more willing to give up personal information when they know who is collecting it and how it will be used. Privacy legislation in the United States, Canada and elsewhere reflect this preference, as companies are required to be transparent with their information gathering methods.

In general, Internet users have raised the following concerns:

1. users would like more control over who is profiling them and how they are being profiled;

2. users seek ways to reduce profiling (e.g. anti-spy ware programs, pop-up blockers, content filtering, anti-spam programs, firewalls, identity theft protection programs, defenses against cookies and web bugs, graphics and means for ad reduction);

3. the solutions described above are numerous and the average user lacks the time and technical know-how needed to compare these solutions;

4. users appreciate the convenience of online shopping and would prefer to receive advertisements that are relevant to them; and

5. users want content that is customized and personalized while eliminating erroneous and annoying advertisement clutter.

Internet service providers (ISPs) have had little control of their customer's experience beyond building a network to provide their customers access to the Internet. Once these customers have established an Internet connection they are left to use the Internet, surfing sites that may include such things as malicious code, objectionable content and irrelevant advertising. ISPs have limited direct contact with their customers to address the above concerns, often recommending or offering third party, client-side applications that the ISPs do no profit from or have control over.

A proposed solution to the above problems and an attempt to replace advertisements received by a user with more relevant advertising (thereby increasing the costs per impression (CPM) for delivered advertisement) uses JavaScript™ applications to analyze page content and user behaviours to deliver advertisements. This solution uses a JavaScript application distributed through web publishers or ISPs. When a user with the installed application (which is tied to their browser) visits a web page, that web page is analyzed for advertisement triggers including keywords, phrases, and URLs. The application then uses a series of cookies and web beacons to report back to centralized server to build an anonymous profile of the particular user. On subsequent page visits to web publishing partners, the centralized server and the JavaScript application make content delivery decisions or provide information to a third party advertisement server to optimize the advertisements.

This solution lacks demographic user data of the user (geography, age, sex etc.), which is often critical for advertising providers. Furthermore, this solution, as a browser add-on, has problems with spy ware and ad ware removal software. Furthermore, the use of a centralized server introduces latency into page delivery and advertisement delivery.

What is needed is a method and system by which targeted advertising can be provided based on personal information of the users which is held by a trusted source and not disclosed to the advertisers.

### SUMMARY OF THE INVENTION

The method and system according to the invention addresses the problem of Internet “clutter” and abuse by providing for Internet content that is personalized and therefore more relevant to the individual user. The system allows Internet users to choose the types of advertisements and content that is most relevant and useful to them while protecting their personal information.

Service providers use a suite of software applications and a server to enable delivery of content, advertising and productivity services linking relevant content to their customers. As well, the system allows the service providers to offer services enhancing the Internet browsing experience of their customers while generating new sources of revenue and improving customer communications. As the software applications and server are situated within the service provider's local network, barriers associated with client-based applications and associated software downloads are eliminated. The services are deployed directly from the service provider network to the subscribers, minimizing costs for deployment and eliminating the need for third-party intervention.

Protection for users from ad ware, spy ware, cookies, web bugs and other invasive schemes are provided by the system through its server and its software. The user's own service provider acts as their personal Internet gatekeeper, providing users with greater control and choice over how their personal information is collected, managed and used by advertisers, allowing the user the choice of opting-in to receive content and advertisements that are relevant and useful to them and opting-out of those that are not.

The system and method according to the invention allows is the tailoring of content to an audience of a single user, which is not possible using broadcast media, such as television or radio. The Internet, however, allows point-to-point communications channels which support individualized, customized content delivery.

A method of modifying content for a computer operated by a user, the user accessing the Internet through a service provider, is provided, comprising: providing a network device receiving communications from said computer, and communications directed to said computer from a content provider in the Internet; said network device receiving a request from the computer addressed to the content provider; said network device accessing a database containing personal information related to the user; said network device using said personal information to determine if said request should be altered; and if said network device determines said request should be altered, altering said request and sending said altered request to the content provider.

The personal information may include user preferences. The alteration to said request may include the addition of encoded relevancy tags. The content provider, on receiving said request, may decode said relevancy tags and send a response to the computer. The network device, on receiving said response from said content provider, uses said personal information to determine if said response is to be altered. The network device may alter the response by blocking said response.

A system for modifying content for a computer operated by a user accessing the Internet through a service provider is provided including a network device within a network related to said service provider, said network server comprising: means for receiving a packet from said computer directed to the Internet; means for receiving a packet directed to said computer from a content provider in the Internet; means for accessing a database containing personal information about the user; means for determining, using said personal information, if said packet from said computer or packet from said content provider, should be altered; means for altering said packet; and means for transmitting said altered packet to said computer or said content provider, as appropriate.

### BRIEF DESCRIPTION OF THE DRAWINGS

FIG. 1 is a block diagram of the system according to the invention;

FIG. 2 is a block diagram showing the system operating between the service provider and a content provider;

FIG. 3 is a block diagram of the operating platform software of a preferred embodiment of the system and method according to the invention; and

FIG. 4 is a flow chart showing an embodiment of an optimization method according to the invention.

### DETAILED DESCRIPTION OF THE INVENTION

### Definitions

In this document, including the claims, the following terms have the following meanings:

“browser” means a program operable on a computer, used for accessing web sites or information on a network;

“computer” means a programmable electronic device that can store, retrieve, and process data and that can transmit information to or from other computers;

“content provider” means an entity that provides content for the Internet, such as a web site. Content providers may provide or distribute advertisements on the Internet, for example by using an advertising server. Examples of content providers are advertising servers, advertising distributors and host servers;

“Internet” means an electronic communications network that connects computers, computer networks and organizational computer facilities around the world and includes the World Wide Web;

“service provider” or “network owner” means an entity that provides users the opportunity to access the Internet by using a computer. A service provider may also be referred to as an “Internet Service Provider” or “ISP”;

“personal information” means information about a user personal to that user, including name, address, contact information, preferences, and financial, familial and professional information;

“network device” means a computer, or software running on a computer, operating with a network LO environment; a network device may be a server;

“relevancy tag” means tags inserted into a file or HTTP data packet (or stored as a separate file associated with another file) to provide additional information. A manifest may be used as a relevancy tag.

“source” means the destination from which a content provider provides content to a computer; and

“user” means an entity, usually a person using software such as a web browser running on a computer to access the Internet.

The System

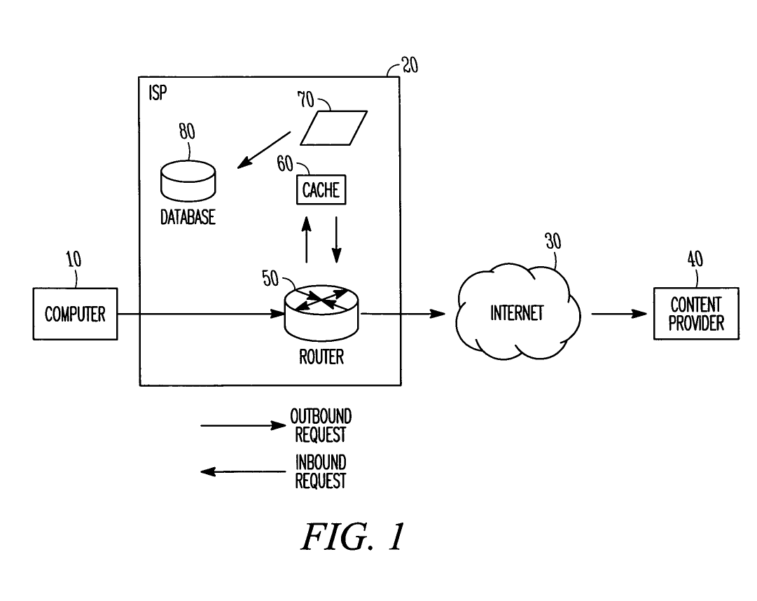

As seen in FIG. 1, users operate a browser on computer 10, and use service provider 20 to access the Internet 30. Content provider 40 provides content to the Internet 30 for users to access. Service provider 20 includes a router 50 to direct messages, usually in the form of packets, from computer 10 to the Internet 30 and back again. Service provider 20 includes cache 60, which communicates with network device 70. Server 70 accesses database 80 to obtain information about the user of computer 10.

Database 80 contains information about users that access the Internet 30 through content provider 20. Such information includes authentication data to permit user to access Internet 30, but also includes personal information such as the user's name, address, and billing information. In a preferred embodiment of the invention, such billing information may include detailed information about the user, including hobbies, preferences, and financial information.

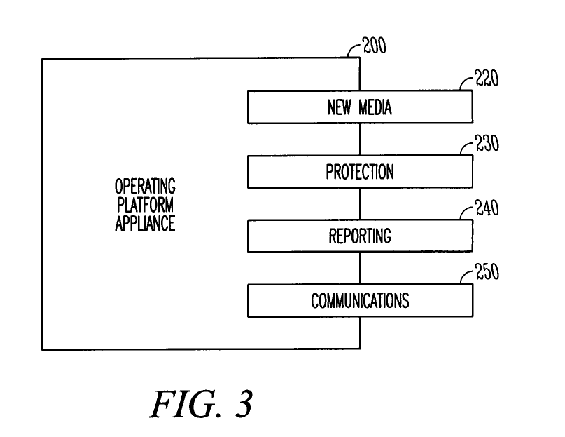

In a preferred embodiment, as seen in FIG. 3, network device 70 includes a software platform 200 that allows service provider 20 to manage data flow both inside of and in and out of service provider 20's network, thereby providing the ability to provide personalized services and content to the users that subscribe to service provider 20.

Network device 70 is positioned inside the network of service provider 20, but on the edge of that network so that communications between computer 10 and Internet 30 are routed by router 50 through network device 70. Network device 70 functions from within a service provider 20's network to strategically place “tailored” communications and advertising content into a user's Internet browser.

Network device 70 is preferably a purpose-built hardware and software device meeting the scalability, reliability, redundancy and performance requirements of service provider networks 20. Network device 70 manages the flow of data inside and into the service provider 20's network environment. Network device 70 is positioned so that in either direction, the content data stream can be redirected through network device 70 and encoded/decoded for the purpose of tailoring the requested/delivered content to the user. Working within the service provider 20's network, network device 70 makes the final content determinations in the “content request/response process”, allowing the addition, removal or blocking of arbitrary information in an HTTP stream of content. Database 80, accessible by server 70 allows server 70 to access user data as necessary to make the determinations necessary to provide the customized services and content for individual subscribers and/or groups of subscribers based upon the business rules and profiles established by service provider 20. Therefore, network device 70 can collect and interpret user-specific information and preferences within the service provider 20 network, encode and encapsulate that information in an outgoing HTTP request, decode information at the content provider 20's server(s), and select, modify or manufacture content in real-time for presentation to individually targeted users.

Network device 70 may be a server, software on a server, and may be spread out on several devices or positioned on one only.

While database 80 and cache 60 are depicted in FIG. 1 as external to network device 70, in alternative embodiments of the invention network device 70 may include cache 60 and database 80 and even router 50.

Operating platform 200 running on network device 70 preferably includes up to four service modules that may be independently implemented. The four service modules may include:

1. Communications module 210 (which may provide services including notifications, billing/collections and promotional services);

2. New media module 220 (which may provide services including advertisement blocking/removal, advertisement insertion, and localized advertising);

3. Protection module 230 (which may provide services including content filtering and virus removal); and

4. Reporting 240 (which may provide services including data collection for advertisement campaigns and web browsing characteristics).

Each of these modules will be described in more detail below.

Operating platform 200 thereby provides service providers 20 with a set of communication tools, including advertisement insertion tools that extend and simplify communications with their customers. Service providers 20 can use operating platform 200 to communicate with their customers while they are browsing websites to deliver information including system notices, virus warnings, billing notifications and marketing promotions.

Bi-Directional Content Flow

The method and system according to the invention uses network device 70, router 50 and cache 60 to tailor and delivering localized and personalized content to individual users operating computer 10. The system uses the Internet 30 as a medium for bi-directional communications, rather than as merely a distribution service for content from content provider 40.

While the preferred embodiment of the invention is described herein as using standards-based network router 50 and cache 60, other tools and means could be used, for example cache 60 may be a server, or part of a server.

As described herein, the system according to the invention uses a protocol, such as the Internet Content Adaptation Protocol (“ICAP”), to allow for the insertion or manipulation of information in a file transmitted to or from computer 10. Using ICAP, as an example, a vector point facility of ICAP allows a manifest file (a type of relevancy tag) to be encapsulated that may contains any amount of arbitrary information, although other file types capable of being transmitted via the appropriate protocol may be used. Using ICAP, the manifest is transmitted with the user's request for Internet information from content provider 40. The manifest originates from within the service provider 20's network and contains information specific to the user who initiated the request. The service provider 20 (and its partners) act as the trusted party storing the content or data being distributed outside the service provider 20's network.

Some examples of information that may be included in the outgoing message (such as the manifest) include: personal information regarding an individual user; data that should be secured and exchanged between the user and the content provider (for example credit card information); browsing characteristics of the user delivered in a format that may be used by content provider 40 to customize the browsing experience for the benefit of the user or content provider 40; advertising or media content that may include rules about how or why certain content should be placed, refinement of targeting criteria, placement values, or graphical elements required to place content within the browser; data collected as the information requested travels along the communications path(s) between the user's computer 10 and content provider 40 or from content provider 40 back to the user's computer 10; or other attributes, data or content.

Service provider 20 (and network device 70 within service provider 20's network) act as trusted keepers of information about the user, so that the system according to the invention safely stores personal information about a user within the service provider 20's network, and secures and encrypts such information both within the service provider 20's network and when adding the personal information to an outgoing message, and generally removes identifiable information (known as “de-identifies” or “anonymizes”) from the user's personal information before allowing it to leave the service provider 20's. This process, whereby a file such as the manifest is constructed or the information is added to an outgoing file, and the de-identification of the user's personal information before it is sent to a content provider 40, is referred to herein as “Internet caller identification” or “Caller ID”.

As described above, in the preferred embodiment of the invention, the browsing content flow from user's computer 10 to the Internet is bidirectional, as the Caller ID content is sent with the user's communications to content provider 40's website (or to a third party to decode the content), where the Caller ID content is examined, decisions made, and then return content is sent from the website 5 back to the user's computer 10. The content provider 40's web site does not need to request the Caller ID content from the user. In a preferred embodiment the system does not employ cookies (as these are variously invasive, and require some degree of cooperation from the user, or at least some naiveté) or customized desktop applications (which require explicit downloading and conscious opt-in on the part of the user).

The system can associate unique subscriber identification of a user as stored in database 80 with the bidirectional HTTP data stream (both requests and responses) transparently, in real-time. The method according to the invention can also add, remove or block selected information in the HTTP stream.

The information included in an outgoing message, such as a manifest, can be used for a multiplicity of purposes. In a preferred embodiment of the invention, the HTTP request is enriched with the addition of encoded user attribute information, stored in database 80, in the form of additional headers. The user attribute information can be garnered from a multiplicity of sources, hi a preferred embodiment, the user attribute information is obtained from matching the EP address of user's computer 10 against a list of users stored in database 80, for instance from the RADIUS authentication database of a participating service provider. Unlike browser cookies, these authentication objects are created by the network device positioned at the edge of the service provider's network.

Using the above method, the user attribute information itself can be sent to the content provider 40, or an encoded key can be sent to content provider 40 instead; this encoded key useful only to the intended recipient (the specific content provider 40). Since the request can be further intercepted along its path by other (perhaps also transparent) proxies and relays, it is often preferable to use the encoded key. The encoded key can be time-limited to further protect the privacy of the user's information. The encryption and encoding method in the preferred embodiment are conventionally available in the art.

The user information (or attributes) can be used at by content provider 40 for several purposes, for example to tailor the presentation of content on content provider's web page to the individual user's computer 10.

The content tailoring can occur in the outgoing flow of content (i.e. the original request made by the user for content from content provider 40), or the incoming flow of content (i.e. the content sent by the content provider 40 to user's computer 10). Network device 70 is positioned so that in either direction, the content data stream may be caught and decoded to modify the content to the user and make alterations. Network device 70 is not limited to any specific type of modification; however, the intended use of the modifications can be broadly described and categorized into the following areas of each type user specific refinement as seen in FIG. 3:

New Media—decoding of advertising related content in order to remove irrelevant advertising content, or creating new white space within existing content, or placing new advertising, or providing a mechanism to allow the content provider to receive media content and approve it for display within the existing content.

Protection—the decoding of browsing data to make real-time decisions to determine if such requests or responses have characteristics of abusive, illegal, or unwanted behavior. The intent is to block any activity such as that from an abusive advertisement server, content provider, pop-up, virus, spy-ware, or any unknown offender deemed to have intent to create computer harm, violate privacy, or perform any other unwanted act.

Communications—creating an event, such as a user message, a notification, or any other desired information, where the message itself is browsing content, and can be used, but not limited by any means, to: replace the entire browsing data content with the communication content; or manipulate the browsing data so that it will contain new instructions that make the user's browser display the message in desired form, for example, a bill payment reminder (the communication content could cause the browser to shrink over time, and continue to shrink until the payment has been made);

Reporting—the act of examining the browsing data, and recording user specific chronology about the behavior of the user. This may include, but is not limited to, the following: performing user modeling; recording performance of advertising; or analyzing segment browsing behavior.

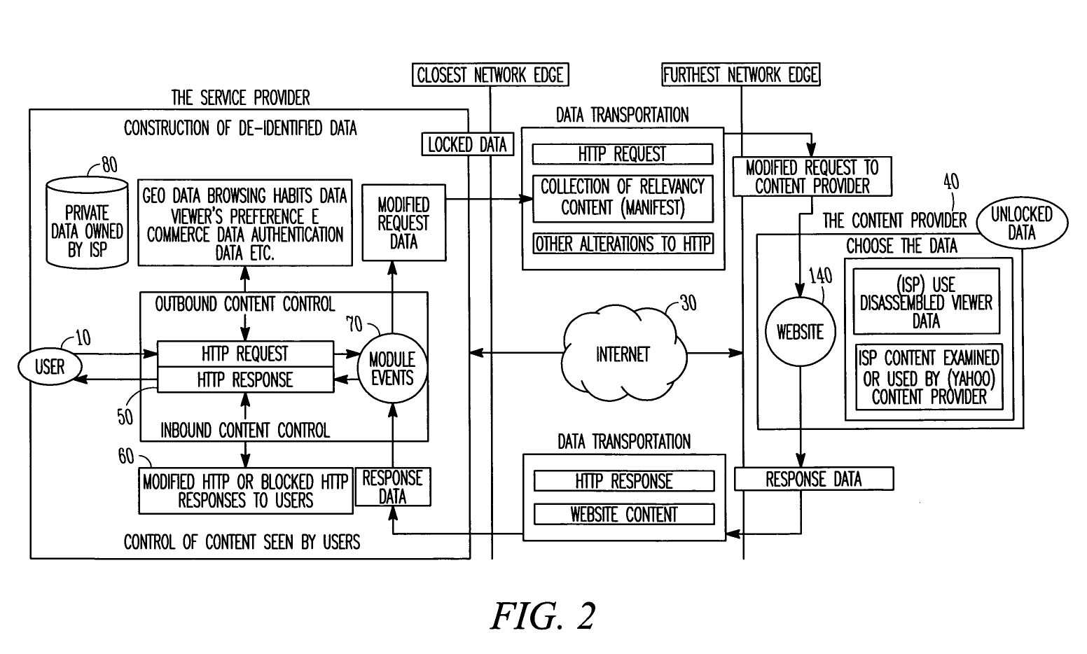

FIG. 2 is a representation of the manner in which network device 70 interacts with user's computer 10, service provider 20 and content provider 40. When user 10 makes an HTTP request, the message is sent to router 50. Network device modifies the HTTP request, and adds information from database 80, and may encode the information. The encoded, modified HTTP request is then sent through the Internet 30 to content provider 40. Content provider 40 decodes the information, and reacts by transmitting an HTTP response. The HTTP response is sent through the Internet 30 and is received by network device 70. Network device 70 checks database 80 to determine if there is content in the HTTP response that should be blocked, and if so stores it in cache 60. The HTTP response may also be modified by Network device 70 to provide more relevant information. The HTTP response is then provided to user's computer 10 via router 50.

Optimization

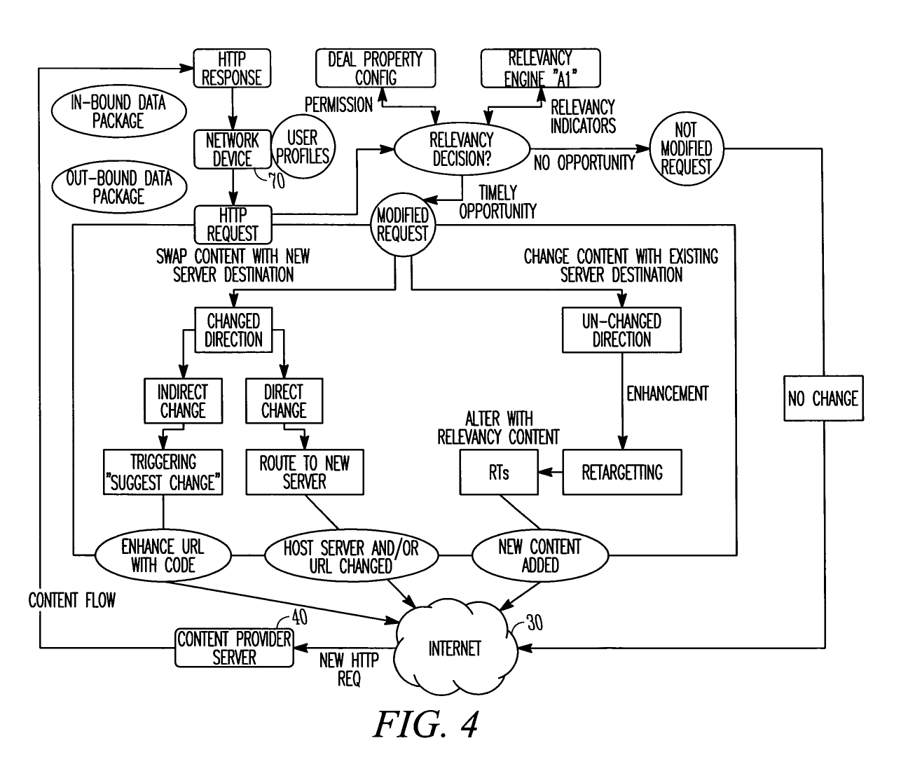

One aspect of the method and system according to the invention is the substitution of content for more relevant content. This requires decision making by network device 70 using database 80 to 15 determine when such substitutions are appropriate. There are several means by which the system can be used to deliver optimized content, some of which are described below. FIG. 4 displays a flow chart showing the process by optimization takes place.

Relevancy

Relevancy involves determining when there is an opportunity to present a relevant advertisement to a user. In a preferred embodiment of the invention, there are two parts to this determination. First, the system determines when an opportunity is available. Then, the system makes a comparative decision to determine the relevancy of the original advertisement opportunity (seen through normal browsing of the Internet) as compared to an alternative advertising opportunity.

The weighting of relevancies is determined by many following factors for example:
(a) Determining opportunities, for example the permission to exchange advertisements and the negotiated rates for acquiring advertising space; the ability to use the system to make real-time predictions about statistically based trends; and advertisement delivery weaknesses, such as a known irrelevant wasteful advertisements from an advertising network as compared to a known more relevant opportunity.
(b) Economic opportunity to benefit the service provider, such as the arbitrage opportunity of the advertisement distribution, i.e. low priced advertisement inventory as compared to premium advertisement yields; and a bidding process that allows the market value of certain type of advertisements to be better related to a better delivery system to the user.

Relevancy can be determined using artificial intelligence to extract general public browsing stream information that forms aggregate statistical trending. Preferably, no humans are involved in the process and the relevancy determination adheres to privacy concerns. The process can work by; 0 examining not what a user does, but by sampling how best pockets of populations can be connected to better, more relevant opportunities.

Pre-Empting

Pre-empting is the process by which network device 70 changes an advertisement request before it is sent to the Internet. When an advertisement request is pre-empted, it is as though the request: 5 never occurred to the content provider or advertisement server for which it was intended to arrive as the network device 70 server changes the destination of the advertisement request. This process may require changing both the uniform resource identifier (URI) and the destination host name of the advertisement request. For example, an http packet may have been originally destined to go to Destination A, is pre-empted, and the packet is modified so that the packet will arrive at a different server at Destination B.

Retargeting

Retargeting also involves changing an HTTP request before it reaches its intended destination. However, rather than changing the destination of the request, the URI is enhanced by network device 70, for example by adding additional parameters, a manifest or other relevancy tags into the HTTP header stream.

Triggering

Triggering involves modifying the HTTP request before it reaches its intended destination. However, like retargeting, the original destination of the HTTP request is not changed. Instead, the request is modified by the insertion of a flag into the URI. The destination content provider 40 or advertisement server reads this flag when the HTTP request arrives. Unlike the retargeting process, the flag is used by the advertisement server to match requests made for advertising space. The flag is placed to suggest to the content provider 40 that a relevant opportunity is available and that the content provider 40 should change the direction of the advertising placement using a redirect response.

### DETAILED EXAMPLE

A service provider (such as a network provider, an ISP, network provider, telecommunications provider, wireless access point, etc) installs network device 70 in proximity to the user such that the user's computer 10's in-bound or out-bound data traffic is accessible to network device 70. The physical location of network device 70 is arbitrary, and may involve the service provider using other devices such as routers 50 to send data packets to a location where network device 70 is installed.

With traffic flowing to the network device 70 as service provider 20 also authenticates a user as a subscriber; the user is given access and permission to the service provider 20's network from which traffic will flow in and out from. The methods for user authentication are arbitrary; however may involve a process such as the use of computer 10 in a wireless hotspot, where the user (subscriber) is required to sign-up or purchase the service, or the use of RADIUS technology, in the case of a dial-up service provider, in which a dynamic Internet address is assigned to the user for monthly access to the service provider 20's network.

In all cases, the mechanisms for authentication of a user involve permission, even if permission is implied originally without a formal user sign-in process, then identifying who the user is rather than the Internet address the may have been temporarily assigned. The current embodiment of the system is seen to accommodate use of any mechanism for authentication of a user, whether it is a proprietary process, an industry standard mechanism, or a future approach.

Once a user is authenticated, the network device 70 receives either in real-time or during regular updates, a code unique to the permitted user (subscriber) profile, hi some cases this may be the billing or accounting code of the service provider. In other cases this may be a static IP address used by the service provider to identify their customers. The nature of the identification method is arbitrary as it is often a unique method used by each service provider's network. The purpose of the identification is to link the user's Internet address to a static unique identifier for the authenticated user on the network.

Once the link between the assigned IP address and the user identifier has been established, the network device creates a user profile that is maintained during the time the user is permitted access to the service provider 20's network. The persistency of the profile allows network device 70 to apply its decision making across all out-bound and in-bound data packets. Network device 70 uses the profile as a mechanism to separate in-bound and out-bound data amongst all other users who have access to the network at the same time. Network device 70 also manages the user's profile so that it may be possible to prescribe decision-making logic, rule-sets, or to store and retrieve data mining variables at any point during the user's activities on the network.

Network device 70 can then access in-bound and outbound data packets and can apply decision making for each user separately. In order to meet a desired end, network device 70 may create “events” or processes to alter the Internet traffic in specific form. For convenience, the events have been divided into four arbitrary categories as seen in FIG. 3. With use of the service provider's stored user profile, network device 70 can use decision making logic to make each alteration opportunity entirely unique amongst other users on the service provider 20's network. Hence, the user profile may determine whether or not to invoke an event at all, or perhaps to apply a particular user customization to the event, or other customized rule or logic. Each category event is built within the systems core modules. Examples of the decision making process are found in FIG. 4, which is a flow chart showing the process by which an HTTP request may be optimized.

Module Category: New Media Event

When network device 70 detects one or more advertising data packets, a media event occurs. This signals network device 70 to apply decision making to the flow of advertising the user is engaging in. The opportunity may be characterized, as a specific detection of data packets not restricted to any particular form of advertising media such as banners, videos, text, etc. The ability to detect the types of advertising media is built on industry standards for advertising distribution.

For representative purposes, this example will assume the user triggered the event on detection of a banner advertising tag that has been requested. The request is transmitted over the service provider 20's network, transported via the Internet, and then destined to arrive to a content provider 40, specifically an advertising server. In this example, the advertising server is obligated to make a decision and send back to the user, a payload of advertising content.

Network device 70 uses “relevancy” to make further decisions about media content alterations. A relevant opportunity is determined if, using network device 70's own decision-making, the result will be the original request being replaced with a new request. The purpose of relevancy is to form business decisions that lay the foundation for understanding why, when, and how, to alter the media; and to propose and rationalize the change. A user's persistent profile may be used to determine relevancy. The software or hardware engine that determines relevancy is arbitrary and may be any number of software or 3^{rd} party systems or logic embedded within network device 70.

In an alternative embodiment, network device 70 may pass the user's profile to a centralized server which performs statistical based trending. Network device 70 may apply several methods to obscure the identity of the user's profile and to ensure that acceptable levels of privacy are maintained.

The engine that determines relevancy then passes the user profile to network device 70 with relevancy indicators/tags. The tags are arbitrary content used to transport a manifest of related data. In this case the data may contain information used to justify the following: lifting the value of the new advertising opportunity; bidding on new advertising opportunities that can be provided in future out-bound directions; outlining statistically based trends that may have been collected from the analysis of past behaviour of the user; characterizing future marketing predictions based on the analysis of common trends consumed by the population of users (subscribers) on the service provider 20's network; enhancing advertising targets with the user's current geography; or linking offline marketing data to the user's profile.

Once the relevancy indicators have been established within the user's profile, network device 70 may invoke an alteration. This alteration benefits one or more, and preferably all stakeholders participating in the alteration opportunity, as described below:

1. The user receives a transparent change from less relevant content to increased relevant media without the need for any invasive software on their computer;

2. The service provider improves the user's (their customer's) browsing experience without introducing increased advertising clutter, while participating within the industry of advertising distribution, and preserving the economies and value chain;

3. The original advertising distributor, web publisher, advertising network, or advertising server, who have consent and receive compensation prior to the alteration being introduced;

4. The original advertiser, who more often wastes an advertising delivery and incurs increased costs for low yield scenarios;

5. The new advertising distributor, web publisher, advertising network, or advertising server, who can more precisely deliver the optimal advertisement opportunity;

6. The new advertiser, who can deliver its messages in a more precise manner, and in some cases may allow new advertisers to use the Internet to reach customers when it was previously not practical or impossible to do so.

Once a relevancy opportunity has been determined, network device 70 can make several types of changes to resulting data packets. Network device 70 may alter the out-bound HTTP request while it is within service provider 20's network, prior to the request being sent out-bound over the Internet, to the destination server. The manifest of relevancy indicators and the user's profile may be used in any number of the following enhancements:

1. Adding New Content Out-Bound to the Opportunity.

In a preferred embodiment network device 70 can uses current Internet protocols (e.g. HTTP 1.0, 1.1, or 1.x) to transmit content out-bound in the user's HTTP request, in normal HTTP communications, content is provided by the user by the user requesting information, having it transported over the Internet to a destination host server operated by a content provider, who in turn delivers a response. Host content servers do not expect to receive content from users unless it is specifically requested, however they may benefit from the value of the content in their current decision making processes.

Network device 70 may alter the HTTP request to transmit content out-bound. Alterations may include embedding relevancy data into HTTP header tags. The data may be used to: make preferable advertisement choices by a destination host web publisher, advertisement network, advertisement server, or other content provider; suggest advertisement bidding opportunities that signal the web publisher, advertisement network, advertisement server, or other content provider to prioritize or accept the network device 70's advertisement content over other advertisement inventories; describe the content data itself, such that decision making using content approval, content clashing, etc. can be reviewed; set expectations about the user's expected advertisement yields or other performance metrics used to match, target, or monetize the content; or for any other purposes.

2. Change the Direction of the Opportunity

Network device 70 can also change the delivery direction of an opportunity or packet in favour of another. In a preferred embodiment of the invention, network device 70 primarily uses the following two methods of altering and reformatting the data packet and content.

Direct Change

In a direct change network device 70 removes the resolved host name or IP address of the destination server contained within the HTTP request and replaces it with a new destination host name or IP address. Network device 70 may also correspondingly alter the original GET request URL so that its call to the new destination host or address is transmitted compatibly. In this scenario the original HTTP request and all if the data and content therein is re-routed from the originally intended direction, then transmitted via the Internet, and arrives at the new server location.

Indirect Change

In an indirect change, the destination of the packet is not changed by network device 70. Instead the destination server is requested to make an independent decision regarding rerouting the HTTP request. In this change, before the out-bound HTTP request is transmitted, network device alters the request URL and appends a trigger code. Content provider 40 will have configured the destination server to recognize this code; independent of network device 70.

As the HTTP request leaves service provider 20's network, it is transmitted over the Internet, and arrives at the destination server. The destination server then reads the URL and its specialized trigger code and matches it with a redirection response containing the changed location address. The original destination server may ignore the trigger code and return its own content or forgo the opportunity in favour of sending its own content.

If the destination server accepts the code and responds with an HTTP redirect response code, it sends an HTTP response back to the user's computer 10. The user's browser then makes another HTTP request, however, now towards the new destination server. Network device 70 then receives the HTTP request as a second “event” for the same transaction, and may make further alterations to the data or content, presumably it does not need to change the destination of the packet again. This method has a similar effect as the direct change, as the directional change would not have occurred if network device 70 had not added the trigger code that signalled the original destination server to redirect to the new destination server.

Retargeting the Opportunity

Network device 70 can create a new media opportunity without changing the original destination server so that the content provider controlling the destination server may deliver different content on its own to user's computer 10, based on reading the relevancy tags contained within the altered HTTP request or perhaps by network device 70 accepting the suggested content from the destination server.

In these cases network device 70 may alter the HTTP request while it is within the service provider 20's network by adding new content, as described previously. The HTTP request is transmitted over the Internet to the destination server where the HTTP request is read. The destination server may use the information to make one of three decisions to: (1) ignore the new content and return its own content in the in-bound direction back to the user's computer 10; (2) use the new content to make better decisions and select its own more appropriate content; or (3) accept the suggested new content at the destination server and return it to the user's computer.

Module Category: Communications Event

The system and method provide opportunities for service provider 20 to communicate messages to users while the users access service provider 20's network. As network appliance 70 can alter inbound and out-bound data packets while maintaining a persistent profile of the user, network appliance 70 is capable of creating a wide range of specialized and individualized messages for users. In this example, the messages may be tied 3^{rd} party systems such as billing payment notices, service interruption notices, marketing/promotional messages, or the protection module for warning user about threats.

Depending on the type of message, the system may apply separate decision-making used to automate specific message events. A specific event can be dispatched based on the following: a scheduled time and day; a matching condition from the user's profile; and/or 3 party systems automation that update the user's profile automatically. Network appliance 70 can be configured to customize each of the following messages for users: an option to set a date and time interval used to describe the effective start and end availability of the message; and/or an option to set the targets of the message so that it can be delivered to groups of users that match the delivery conditions. These conditions may include any portion of the user profile or relevancy tags; an Internet address range or a geographical break down or users serviced within the network owners wide area infrastructure.

The option to provide the message to users automatically may be based on a triggering event such as a 3^{rd} party system that automatically invokes the event (for example a 3^{rd} party billing system that sends a list of delinquent user accounts and triggers a billing payment reminder communications notice); a process within network device 70 that detects a specific behaviour the user is engaging in and triggers a notice; or any of the existing category events (Media, Protection, Reporting). An example might be the protection module, when detecting the occurrence of a virus, automatically dispatches a virus warning and makes an announcement to the individual of an impeding threat.

Network device 70 provides options regarding the customization of the message. For example the look and feel of the message may be modified to display customized information for a user or category of user to create template messages used to drive specific events that are automated. The template fields may be inserted into the look and feel of the message. These fields may contain elements of the user's profile such that when the message is invoked the contents appear with substituted values. An example might be to personalize a message with the user's name.

Another option might be to determine the number of times the message will be displayed to a user in sequence. In this case a user may see a payment reminder notice lasting the next 10 web pages they send messages to. Yet another option is to determine the length of time the message will be displayed to the user. In this case a user may see a payment reminder notice lasting for 10 minutes regardless of the number of web pages they visit.

A further option in a message is to include an action request by the user such as an acknowledgment or an agreement. In this case a user views a payment reminder notice and isn't permitted to browse to other pages until they update their information on the page with a new credit card number. The service provider could in turn make a real-time credit approval transaction to further validate the account have been successfully paid.

Preferably, a communications message may deliver content in two methods. In the first method a new full web page is displayed by network device 70 either before or after a page the user originally requested. This appears as if the message was displayed between the occurrences of two pages. In the second method, the original content of the request web page is modified by network device 70 so that it is shared with the message. For example the user may go to website such as yahoo.com, and see the entire contents of the web page are pushed down. New white space is created in the top portion of the browser. The web page itself is mechanically separated such that the original page is contained within its own HTML start and end tags. The new content is also separated within its own HTML start end tags with the additional placement of a line between both sets of content so that they are both visibility denoted by the user. By placing each set of content in separate HTML start and end tags the browser can decipher that there are two sets of content being displayed on the page at the same time. Therefore the user will no believe the message originated from the requested web site, such as Yahoo!™.

As example, of a situation where communications from a third party using automation is an Amber Alert situation. In this case, an Amber alert is created because a child has been abducted. The alert system is located in a central database that dispatches an announcement to the effected areas, including to service provider 20. Service provider 20 provides its services to one of the effected areas where network device 70 has been installed. Network device 70 receives the announcement by the Amber Alert technology in which the content regarding the abducted child is placed into the communication module and creates an automatic event. In this example, the entire user base in the effected area is targeted.

A user browsing the Internet on computer 10 receives the event while they are requesting a web page, for example the Yahoo.com home page. In the out-bound data packets, the HTTP GET requested URL “Yahoo” is replaced with a URL that directs the user to the Amber alert abducted content page. The user views a full-page message using their browser. The content is only displayed for 30 seconds. The content page is constructed so that it automatically refreshes and continues to the web page it was originally intended to go to. The user's browser then requests the Yahoo.com page and continues browsing as previously. In this example, the user is no longer targeted by the message as its frequency setting was configured to last only 30 seconds.

Module Category: Protection Event

Network device 70 can invoke a specific event when a threat situation is determined. As content is typically received from content provider 40 back to the user's computer 10, there is often little control available to the user to intercept malicious data, other than installing specialized software such as spy ware detectors, virus scanner, phasing detectors, etc. These approaches are often not used until after computer 10 is infected with the malicious data as they are installed as a reaction to correct the problem. As network device 70 can observe both in-bound and out-band data traffic and can alter packets of data proactively before they are received by user's computer 10. A protection event may also invoke a communications event if it is necessary to send a message to the user of the threat in progress.

Network device 70 can detect malicious data among both an inbound and outbound data transmissions. When making an outbound determination, network device 70 can determine that the user's computer 10 has malicious infections. For example, in the case user's computer 10 is infected with spy ware, which has a goal of transmitting the user's personal information to a host server located in China.

In this example, the spy ware software initiates an HTTP request using the host name of the Chinese server, and includes encrypted data with the user's personal information in the URL. The user is unaware of the HTTP request as it is fetched from the Internet browser on computer 10. System provider 20 then transmits the HTP request data packet to network device 70.

Network device 70 detects that the packet is a spy ware HTTP request and blocks the request by using a forbidden access HTTP code. Network device then triggers a communications event and sends a message to computer 10 that warns the user they have spy ware on their computer with instructions on removing the spy ware safely.

In the case of malicious data arriving with an inbound message, network device 70 can observe that the in-bound content has malicious code embedded in the data stream. For example, a user receives an email that includes an image of a teddy bear. This teddy bear image is located and referenced by an HTTP call to a server in Germany. The user's computer 10 requests the image by sending the HTTP call. Service provider 20 transmits the HTTP request to the German server, which responds by transmitting several data packets inbound to computer 10.

The first packet delivered by the server in Germany is the teddy bear image, but a second packet contains a spy ware threat. Service provider transmits the inbound packets to network device 70 before they are delivered to the user's computer 10. Network device 70 detects the second packet as spy ware and invokes the protection event. The protection event calls the spy ware removal program and alters the packet so that it no longer contains the spy ware threat. The packets of data, now safe, are delivered safely to the user's computer 10.

The methods for detecting a threat are available in the art and many companies, such as Symantec Corporation, produce configuration data and products that can be used by network device 70 so that network device 70 can accurately alter the packets.

An advantage of network device 70 is that it can also be used to exclude the delivery of certain types of abusive content the user has opted not to receive. For example, if a user does not like popup advertising they may notify service provider 20 that the user would like to exclude this type of media. System provider 20 selects the user's profile within database 80 and creates a relevancy indicator to opt-out of any form of pop-up advertising. The user later sends an HTTP request to Google for content. The services provider 20 sends the HTTP request content to network device 70.

Network device 70 invokes a protection event as the user's persistent profile signals it to opt-out of pop-up advertising. Network device 70 alters the out-going data packet and places a relevancy tag with content that indicates “No Pop-ups”. The altered HTTP request is delivered over the Internet to the Google content server. Google understands the HTTP request and the opt-out relevancy tag and removes any search results from content lists that use pop-up advertising (Google is aware what sites use pop-up advertising as they use robots to crawl and index the Internet). The Google content is transmitted back to the user's computer who is secure that the search results they review do not lead to pop-up advertising.

Module D: Reporting Event

The system and method according to the invention is able to observe out-bound and in-bound HTTP requests. The HTP protocol observed in the data stream not only contains content but also may contain other valuable data mining opportunities. The use of this data is a component to the functioning of the system as it can serve as the basis for several event types. For example, when data packets are passed to the relevancy engine to determine data about statically based trends, network device 70 may use these trends to create new relevancy indicators that may develop into content sent out-bound in user HTTP data packets. Stored characteristics of the data in database 80 should have a preserved chronology and can be used for analysis opportunities. Network device 70 may use other systems to analyze the data and create new data points or may use the data internally for the sole benefit of service provider 20.

If network device 70 determines a data event has occurred it may choose to transmit fire a subsequent module event. For example, if a user uses a PDA to browse the service provider 20's network, service provider 20 sends the data packet to network device 70. Network device 70 is configured to being a data event when the user's browser agent tag in the HTTP protocol matches the PDA type. As this condition is met, network device 70 invokes the data event and stores a count of the occurrence in a record in database 80. Network device 70 also invokes a communication event. A message is invoked and informs the user that their PDA is not supported properly on the network and potentially has vulnerabilities and poses threats to other users on the network.

The uses of the data collected are many and varied and provide a wide range of opportunities. For example the data could be used to determine the top ranking web publishers in specific demographical regions; the frequency of advertisement impression opportunities, not limited to any type of advertisement media such as video, text, banners, etc.; the measuring of key performance indicators such as the counting of deal opportunities that are bid on in the out-bound data packets versus the number of accepted content swaps accepted by the content provider's server in the inbound data packet.

Other uses of the data include the assessment of the protection and “health” of user's computer 10. Network device may determine if the user's computer is healthy or unhealthy by counting the average number of threats seen and comparing it to an average threat ratio. This may be used to determine if the user needs to be informed that assistance is required or they should be provided a higher degree of customer care.

Yet another use is the measuring of the number of opportunities of a competitive advertisement. It is possible for network device 70 to determine the frequency with which users interact with a specific business or to observe other advertising campaigns and their performance. Network device 70 could also be used to tag users and target them for advertisers with competitors content by invoking a media event.

Some other uses include selling privacy compliant data feeds to third parties. Network device 70 could store information sought by companies like Net Nielson™, Hitwise™, or Revenue Science™. Network device 70 can generate reports to service provider 20 to aid in understanding the needs of their subscribers. These needs may become marketing targets for advertisers. Service provider 20 may use the data to launch new specialized services based on what is in demand. Network device 70 can also create user surveys by displaying a communication event used to collect additional information from the user. This information be later analyzed and summarized.

Other Uses

The system and method according to the invention have many uses. For example, users could personalize software such as their web browsers, so that local football fans may receive advertisements for their team's season ticket promotions, play-off schedules and even up-to-the-minute scorekeeping. Business travelers may be alerted to deals at local restaurants, local dry cleaners and local fitness clubs that are closest to their hotel of choice. Music fans may be kept up- to-date on new releases, pre-sale ticket promotions and concert dates for their favorite artists and musical genres.

The system and method can also be used to send virus warnings, disconnection warnings, scheduled service interruptions, marketing promotions, and the like automatically to each of the service provider's subscribers. Unlike email and homepage notices, these communications reach the subscribers as they browse the Internet, thereby increasing the service provider 20's ability to reach users. Also, as network device 70 can monitor authentication data and match it to a user (subscriber) profile, service providers 20 will be able to track overdue accounts, send billing/accounting notices and collect outstanding monies.

Some further examples of use of the system include:

Marketing Promotions—This feature allows service provider 20 to introduce a new sales tool by using network device 70 to insert advertisements for new service offerings, added features, or sales promotions directly to their subscriber's browsers as they surf the Internet.

System Notices—Similar to inserting advertisements for new services, network device 70 also allows service providers 20 to schedule automated communications to notify their subscribers of planned service interruptions or system maintenance outages.

Virus Warnings—Service providers 20 can build customer loyalty and preemptively protect their own systems from attacks by using network device 70 to proactively notify users of potential virus threats.

Billing/Accounting—Customer notifications for credit card expirations, or notifications of new credit card charges can be delivered via the customer's browser.

Collection Notices—Network device 70 can automatically detect and notify customers of overdue balances, late payments etc. reducing the need for accounting audits and/or collections agencies.

Revenue Generation—As service providers 20 evaluate and select new value-added and revenue generating services, a usual obstacle is the user requirements, as the majority of protection and content related services are delivered via client side solutions, requiring subscribers to download, install and set-up new software. While these may deliver the desired benefit to the user, the service providers are often left to support solutions that they have little or no control over. The system and method according to the invention allows service providers 20 to quickly deploy new services by delivering them from within the service provider network, thereby eliminating the need for user intervention and third party client software installations, and simplifying the delivery of new services.

Content Management/Localized Content—The system and method according to the invention can be used to deliver localized content (e.g. advertisements) based on demographic and geo-targeted information about the subscriber to users. For example, service providers could include advertisements from local advertisers looking to access their customer base; from global advertisers looking to access their market region; or from content providers looking to access the service provider's local market. In this case, user HTTP requests are routed through network device 70 prior to being sent to their destination server to be fulfilled. Responses are redirected through network device 70, which inserts content (for example, a local advertisement) into the destination server HTTP response before delivery to the user who originated the HTTP request.

Ad Reduction/Ad Parking—The system and method according to the invention can be used to block banner advertisements thus reducing the number of advertisements a user is typically exposed to. The system and method can also be used for “ad parking”, which retrieves, but does not display an advertisement, allowing users to simply move their mouse over an icon should they choose to view the advertisement within a delivered web page.

Content Filtering—Content filtering allows service providers 20 to block or alter web pages before they are sent to a subscriber's computer. The service provider 20 can also rate web pages visited by the type of content they contain. In an example of content filtering, using an iCAP enabled cache or layer 4 switch, user HTTP requests are routed through network device 70 prior to being sent to their destination server. Network device 70 examines outbound HTTP requests against the user preferences stored in database 80 and then encodes/encapsulates those user preferences into the outbound HTTP request. This new header information is included in the original user HTTP request when it is sent to the destination server operated by a content provider 40, allowing the HTTP response to be delivered containing any requested modifications (e.g. removal of content, blocking, etc.).

Fraud Protection—Service providers 20 can use the system and method according to the invention to protect users who request content from content provider's web sites known to have been involved in fraudulent transactions. Using a list of known offenders, a message can be delivered to a user notifying them of reports of malicious activities and allowing them to choose whether to continue on or to learn more about the offending web site.

Other examples of use of the system and method according to the invention include:

1. An internet advertising mechanism closely modeled after television broadcasting functions for delivering local content to local audiences, much like traditional simulcasting, as network device could deliver the same content to all of a service provider 20's users.

2. The distribution of content outbound to a content provider, allowing the content provider to examine the costs and selection criteria of the content delivered, and to make a decision to accept or reject the content based on the merits of the content in question.

3. A broadcasting network that consists of several network devices 70 within various service provider 20 networks and a top-level media center network device 70 that can aggregate the users within each server provider 20 network, thereby forming an audience.

4. A safety barrier between users and the content providers 40 so that disclosure of information is unidentifiable.

5. A mechanism by which content providers 40 can gain access and deliver their own tailored content to selective users within a broadcasting audience by accessing network device 70. The users can be considered as viewers of content, advertising impressions, and/or any other data, or mining of information that has characteristics of the audience's behavior.

The method or system described above may implemented by a computer-readable medium having recorded thereon statements and instructions for execution by a computer to carry out the method. Furthermore, the method may be implemented by a computer program product, comprising a memory having computer readable code embodied therein for execution by a CPU. In yet another embodiment, the method according to the invention may be implemented as a carrier wave embodying a computer data signal representing sequences of statements and instructions which, when executed by a processor cause the processor to perform the method.

Although the particular preferred embodiments of the invention have been disclosed in detail for illustrative purposes, it will be recognized that variations or modifications of the disclosed apparatus lie within the scope of the present invention.

What is claimed is:

1. A method of processing a request for an advertisement for presentation to a user in a web page, the method comprising:
in an Internet Service Provider (ISP) network,
receiving an HTTP advertisement request from a user device, the advertisement request destined for an associated destination content server;
intercepting the advertisement request prior to communication of the advertisement request by the ISP network to the associated destination content server;
accessing user data associated with the user; and
modifying the advertisement request by including a trigger code that triggers the associated destination content server to redirect the advertisement request to a new destination content server.

2. The method of claim 1, wherein the trigger code is inserted into a Uniform Source Identifier (URI) of an outbound HTTP request, the trigger code being based on the user data.

3. The method of claim 1, wherein the trigger code is associated with a redirection response at the associated destination content server, the redirection response including a changed location address.

4. The method of claim 1, wherein the trigger code is to request the associated destination content server to forgo an advertisement opportunity.

5. The method of claim 1, further comprising:
receiving the user data at a media center from a plurality of network devices provided within a plurality of ISPs, each network device receiving advertisement requests; and
aggregating the user data from the plurality of network devices.

6. The method of claim 5, further comprising mining the aggregated user data to obtain behavior characteristics of a plurality of users.

7. The method of claim 1, further comprising basing a relevancy of an advertising opportunity on the user data.

8. The method of claim 1, further comprising bidding on an advertising opportunity based on the user data.

9. The method of claim 1, further comprising:
at a network device within the ISP network,
redirecting the advertisement request to an advertising module at the network device;
investigating reference data in an ISP database to obtain the user data;
modifying the advertisement request based on the user data to provide a modified advertisement request; and
communicating the modified advertisement request to a target content server.

10. The method of claim 1, wherein the new destination content server is an advertisement server to provide a targeted advertisement in response to the advertisement request from the user device.

11. The method of claim 1, wherein the user data is an attribute to facilitate selection of a targeted advertisement based on the user data.

12. The method of claim 11, further comprising:
providing the attribute based on the user data; and
including the attribute in the modified advertisement request, the attribute being obtained from matching an IP address of the user device against a list of users in an ISP database.

13. The method of claim 12, further comprising obtaining the IP address from a RADIUS authentication database of the ISP network.

14. The method of claim 1, wherein the advertisement request is for graphical elements for placement within a browser.

15. The method of claim 1, further comprising anonymizing the user data so that personal information associated with the user of the user device is not sent to the destination content server.

16. The method of claim 1, further comprising utilizing Vector Point functionality in Internet Content Adaptation Protocol (ICAP) to communicate the user data to the destination content server.

17. The method of claim 1, wherein the user data comprises information associated with a subscriber, browsing characteristics of the subscriber, data associated with a plurality of users that access the Internet through the ISP network, or authentication data to permit a user to access the Internet.

18. The method of claim 1, wherein the user data is associated with a tag useable by a destination content server to identify an advertisement for communication to the user device.

19. The method of claim 1, wherein the network device is operated in conjunction with a router that functions within the ISP network.

20. The method of claim 19, further comprising:
accessing an ISP database that stores business rules and user profiles; and
modifying the advertisement request from the user device based on a business rule and a user profile.

21. A system to process a request for an advertisement for presentation to a user in a web page, the system comprising:
a network device in an Internet Service Provider (ISP) network, the network device configured to:
receive an HTTP advertisement request from a user device, the advertisement request destined for an associated destination content server;
intercept the advertisement request prior to communication of the advertisement request by the ISP network to the associated destination content server;
access user data associated with the user; and
modify the advertisement request by including a trigger code that triggers the associated destination content server to redirect the advertisement request to a new destination content server.

22. The system of claim 21, wherein the trigger code is inserted into a Uniform Source Identifier (URI) of an outbound HTTP request, the trigger code being based on the user data.

23. The system of claim 21, wherein the trigger code is associated with a redirection response at the associated destination content server, the redirection response including a changed location address.

24. The system of claim 21, wherein the trigger code is to request the associated destination content server to forgo an advertisement opportunity.

25. The system of claim 21, further comprising a media center configured to receive user data from a plurality of ISP networks to provide aggregated user data.

26. The system of claim 25, wherein the aggregated user data is mined to obtain behavior characteristics of a plurality of users.

27. The system of claim 21, wherein relevancy of an advertising opportunity is based on the user data.

28. The system of claim 21, wherein an advertising opportunity is bid on based on the user data.

29. The system of claim 21, wherein the network device comprises:
an advertising module to which the advertisement request from the user device is redirected; and
an ISP database including reference data, wherein the reference data is investigated to obtain the user data.

30. The system of claim 21, wherein the request is an outbound HTTP request from the user device to the destination content server.

31. The system of claim 21, wherein at least one of the associated and new destination content servers is an advertisement server to provide a targeted advertisement in response to the advertisement request from the user device.

32. The system of claim 21, wherein the user data is an attribute to facilitate selection of a targeted advertisement based on the user data.

33. The system of claim 32, wherein the attribute is based on the user data and the attribute is included in the modified advertisement request, the attribute being obtained from matching an IP address of the user device against a list of users in an ISP database.

34. The system of claim 33, wherein the IP address is obtained from a RADIUS authentication database of the ISP network.

35. The system of claim 21, wherein the network device is provided on an edge of an ISP network.

36. The system of claim 21, wherein the user data is anonymized so that personal information associated with the user of the user device is not sent to the associated destination content server.

37. The system of claim 21, wherein the user data comprises information associated with a subscriber, browsing characteristics of the subscriber, data associated with a plurality of users that access the Internet through the ISP network, or authentication data to permit a user to access the Internet.

38. The system of claim 21, wherein the user data is associated with a tag useable by the destination content server to identify an advertisement for communication to the user device.

39. The system of claim 21, wherein the network device is operated in conjunction with a router that functions within the ISP network.

40. A machine-readable medium embodying instructions to process a request for an advertisement for presentation to a user in a web page, the instructions, when executed by a machine, cause the machine to:
in an Internet Service Provider (ISP) network,
receive an HTTP advertisement request from a user device, the advertisement request destined for an associated destination content server;
intercept the advertisement request prior to communication of the advertisement request by the ISP network to the associated destination content server;
access user data associated with the user; and
modify the advertisement request by including a trigger code that triggers the associated destination content server to redirect the advertisement request to a new destination content server.

41. A system to process a request for an advertisement for presentation to a user in a web page, the system comprising:
in an Internet Service Provider (ISP) network,
means for receiving an HTTP advertisement request from a user device, the advertisement request destined for an associated destination content server;
means for intercepting the advertisement request prior to communication of the advertisement request by the ISP network to the associated destination content server;
means for accessing user data associated with the user; and means for modifying the advertisement request by including a trigger code that triggers the associated destination content server to redirect the advertisement request to a new destination content server.
